(19) United States
(12) Patent Application Publication
(10) Pub. No.: US 2025/0330257 A1
(43) Pub. Date: Oct. 23, 2025

(54) WAVELENGTH CROSS CONNECT DEVICE AND WAVELENGTH CROSS CONNECT METHOD

(71) Applicant: Nippon Telegraph and Telephone Corporation, Tokyo (JP)

(72) Inventors: Haruka MINAMI, Musashino-shi, Tokyo (JP); Takeshi SEKI, Musashino-shi, Tokyo (JP)

(21) Appl. No.: 18/854,619

(22) PCT Filed: Apr. 12, 2022
(86) PCT No.: PCT/JP2022/017572

§ 371 Date: Oct. 7, 2024

(51) Int. Cl. H04J 14/02; H04B 10/27; H04Q 11/00

(52) U.S. Cl. CPC H04J 14/0212; H04B 10/27; H04Q 11/0005; H04Q 2011/0016

(57) ABSTRACT

A WXC device includes: input ports; output ports; a wavelength conversion unit including input-side WSSes, wavelength converters, and output-side WSSes; and a controller. The input-side WSSes each output an optical signal input from a corresponding one of the input ports to a selected one of the wavelength converters. The wavelength converters each convert a wavelength band of the optical signal input from each of the input-side WSSes into another wavelength band and output the converted optical signal to a respective one of the output-side WSSes. The output-side WSSes each perform route switching on the optical signal input from the respective one of the wavelength converters toward a selected one of the output ports. The controller manages, for each of the wavelength converters, whether the wavelength converter is unused and controls the input-side WSSes each to output the input optical signal to one of the unused wavelength converters.

### CROSS-REFERENCE TO RELATED APPLICATIONS

This is a National Stage Application of PCT Application No. PCT/JP2022/017572, filed on Apr. 12, 2022. The disclosure of the prior application is considered part of the disclosure of this application, and is incorporated in its entirety into this application.

### BACKGROUND

### Technical Field

The present invention relates to a wavelength cross connect device and a wavelength cross connect method.

### Background Art

A wavelength cross connect (WXC) device used in an optical transmission system is a device that performs route switching (cross connect) on an optical signal input via an input port to an output port indicated by a set wavelength path. A wavelength selective switch (WSS) inside the WXC device outputs a wavelength multiplexed signal beam transmitted from an input port to a desired output port according to the set wavelength path.

The wavelength continuity constraint, which enforces an optical signal be transmitted continuously in one optical path from a start point to an end point using the same wavelength, can now be avoided by a converter that converts the wavelength of the optical signal in the middle of the optical path. WXC devices including a wavelength converter has been also proposed below.

The converter (wavelength-band-inversion (WBI)) described in Non-Patent Literature 1 reduces deterioration of transmission quality due to inter-band Raman scattering.

The all-optical wavelength converters (AO-WCs) described in Non-Patent Literature 2 increases the processable traffic amount.

### CITATION LIST

### Non-Patent Literature

Non-Patent Literature 1: H. Kawahara et. al., “Cancellation of Static and Dynamic Power Transitions induced by inter-band Stimulated Raman Scattering in C+L-band WDM Transmission,” 2020 Opto-Electronics and Communications Conference (OECC) (2020).
Non-Patent Literature 2: M. Nakagawa et. al., “Adaptive Link-by-Link Band Allocation: A Novel Adaptation Scheme in Multi-Band Optical Networks,” 2021 International Conference on Optical Network Design and Modeling (ONDM) (2021).

### SUMMARY OF THE INVENTION

### Technical Problem

In a conventional configuration in which converters are provided in a WXC device, a large number of converters are required for each input/output port of the WXC device. However, only a few of the large number of converters are in operation, and in a case where there are a small number of optical signals for which wavelength conversion is necessary while passing through the WXC device, it is expected that many of the installed converters will not be used.

That is, it is not economical to provide extra converters in the WXC device. On the other hand, when an insufficient number of converters are provided in the WXC device, there is a concern about performance degradation of the WXC device.

In this respect, a main object of the present invention is to propose a configuration of a WXC device for which the number of converters to be included in the WXC device is appropriately set.

### Solution to Problem

In order to solve the above problems, a wavelength cross connect device of the present invention has the following features.

An aspect of the present disclosure is a wavelength cross connect device including:
one or more input ports;
one or more output ports;
a wavelength conversion unit comprising one or more input-side wavelength switches, a plurality of wavelength converters, and a plurality of output-side wavelength switches; and
a controller,
wherein each of the one or more input-side wavelength switches is configured to output an optical signal input from a corresponding one of the one or more input ports to a selected one of the plurality of wavelength converters,
wherein each of the plurality of wavelength converters is configured to convert a wavelength band of the optical signal input from each of the one or more input-side wavelength switches into another wavelength band and output the converted optical signal to a respective one of the plurality of output-side wavelength switches,
wherein each of the plurality of output-side wavelength switches is configured to perform route switching on the optical signal input from the respective one of the plurality of wavelength converters toward a selected one of the one or more output ports of the wavelength cross connect device, and
wherein the controller is configured to:
   manage, for each of the plurality of wavelength converters, whether the wavelength converter is in an in-use state or an unused state to identify zero or more unused wavelength converters among the plurality of wavelength converters; and
   control each of the one or more input-side wavelength switches to output the optical signal input to the input-side wavelength switch to one of the zero or more unused wavelength converter.

### Advantageous Effects of Invention

According to the present invention, it is possible to propose a configuration of a WXC device capable of appropriately setting the number of converters to be included in the WXC device.

### BRIEF DESCRIPTION OF DRAWINGS

FIG. 1 is a configuration diagram illustrating a WXC device with a single-band configuration according to the present embodiment.

FIG. 2 is an explanatory diagram illustrating input/output lines of a wavelength conversion unit with the single-band configuration according to the present embodiment.

FIG. 3 is a configuration diagram illustrating details of the wavelength conversion unit and a controller in the single-band configuration according to the present embodiment.

FIG. 4 is a configuration diagram illustrating a WXC device with a multi-band configuration according to the present embodiment.

FIG. 5 is an explanatory diagram illustrating input/output lines of a wavelength conversion unit with the multi-band configuration according to the present embodiment.

FIG. 6 is a configuration diagram illustrating details of the wavelength conversion unit and a controller in the multi-band configuration according to the present embodiment.

FIG. 7 is a hardware configuration diagram of the controller according to the present embodiment.

### DESCRIPTION OF EMBODIMENTS

Hereinafter, embodiments of the present invention will be described in detail with reference to the drawings. The present embodiment is classified into the following two examples.

In common to the two examples, a WXC device (wavelength cross connect device) has input and output ports for inputting and outputting optical signals of a plurality of wavelength bands (multi-bands) and has WSSes for performing wavelength selection/route switching on the optical signals from the input ports to be transmitted from the output ports.

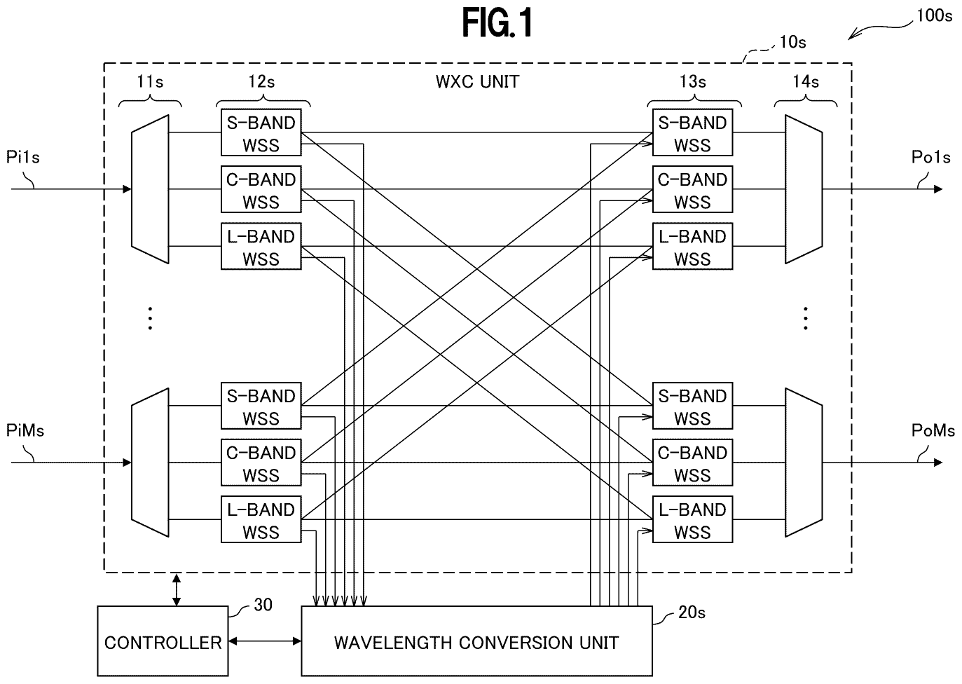

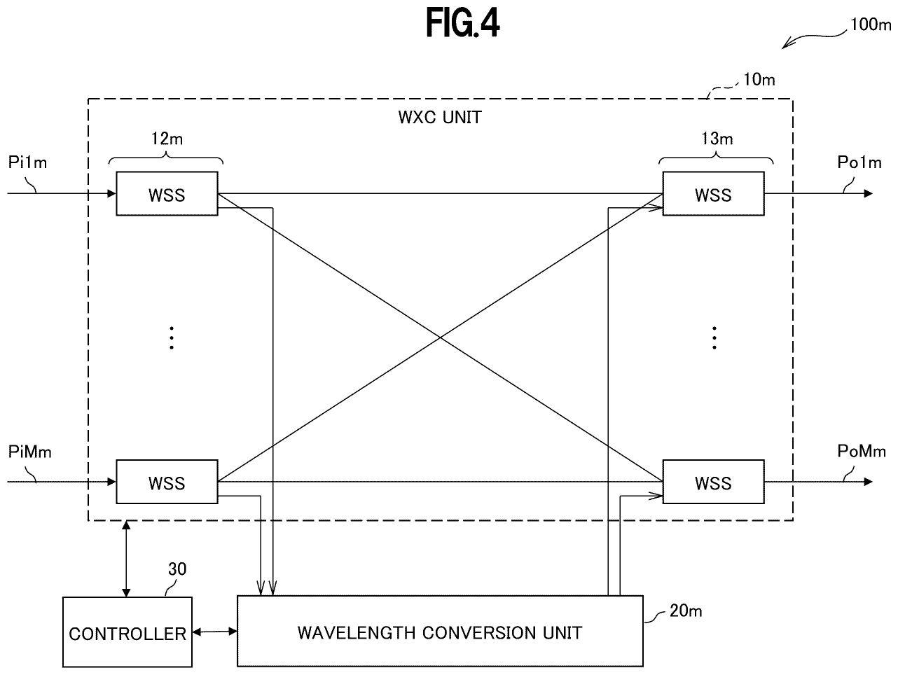

On the other hand, a difference between the two examples is the type of the WSSes used.
(Example 1) A WXC device 100s illustrated in FIGS. 1 to 3 uses WSSes (with a single-band configuration) capable of performing wavelength selection/route switching on one wavelength band (single band). The suffix “s” of the reference signs of constituent components in the WXC device 100s indicates the single-band configuration.
(Example 2) A WXC device 100m illustrated in FIGS. 4 to 6 uses WSSes (with a multi-band configuration) capable of collectively performing wavelength selection/route switching on a plurality of wavelength bands (multi-bands). The suffix “m” of the reference signs of constituent components in the WXC device 100m indicates the multi-band configuration.

Note that the wavelength bands are, for example, the following three wavelength bands, in ascending order from the short-wavelength: S band of 1,460 nm to 1,530 nm: C band of 1,530 nm to 1,565 nm, and L band of 1,565 nm to 1,625 nm.

### Example 1

FIG. 1 is a configuration diagram illustrating the WXC device 100s with the single-band configuration.

The WXC device 100s is connected to external devices by optical fibers via M input ports (port Pil, . . . , port PiM) and M output ports (port Pol, . . . , port PoM), respectively. An optical signal of a plurality of wavelength bands is transmitted/received to/from the optical fiber connected to each input/output port of the WXC device 100s.

The WXC device 100s includes a WXC unit (wavelength cross connect unit) 10s, a wavelength conversion unit 20s, and a controller 30. The controller 30 (see FIG. 3 for details) controls the WXC unit 10s and the wavelength conversion unit 20s.

The WXC unit 10s receives an optical signal in which optical signals of a plurality of wavelength bands have been multiplexed from each input port of the WXC device 100s and inputs optical signals resulted in demultiplexing the received optical signal into distinct wavelength bands to the wavelength conversion unit 20s. In addition, the WXC unit 10s multiplexes optical signals output from the wavelength conversion unit 20s and each having a distinct wavelength band and outputs the multiplexed optical signal from an output port of the WXC device 100s.

That is, the WXC unit 10s performs route switching by itself on optical signal(s) for which wavelength conversion is not necessary and transmits optical signal(s) for which wavelength conversion is necessary to the wavelength conversion unit 20s. With this, the route switching is performed without deterioration in the transmission quality due to wavelength conversion. Note that, the configuration in which the wavelength conversion unit 20s is separated as a constituent component different from the WXC unit 10s is also referred to as of the trunk type.

In the WXC unit 10s, demultiplexers 11s, input-side WSSes 12s, output-side WSSes 13s, and multiplexers 14s are connected in this order from the input port side (left side in FIG. 1).

The M demultiplexers 11s are connected one-to-one to the M input ports, respectively. Each demultiplexer 11s demultiplexes a multi-band optical signal (an optical signal in which an S-band optical signal, a C-band optical signal, and an L-band optical signal have been multiplexed) input from the respective input port into single-band optical signals (the S-band optical signal, the C-band optical signal, and the L-band optical signal). Each demultiplexer 11s then outputs each demultiplexed optical signal to an input-side WSS 12s provided at the subsequent stage for a specific wavelength band.

For example, the first demultiplexer 11s that has received the first optical signal from the first input port Pil demultiplexes the first optical signal into three optical signals. The first demultiplexer 11s then outputs a demultiplexed S-band optical signal to an S-band input-side WSS 12s, outputs a demultiplexed C-band optical signal to a C-band input-side WSS 12s, and outputs a demultiplexed L-band optical signal to an L-band input-side WSS 12s.

The input-side WSSes 12s are configured on a per-wavelength-band basis, like as an S-band WSS, a C-band WSS, and an L-band WSS, and each receive an optical signal of a respective wavelength band from a demultiplexer 11s. That is, as the input-side WSSes 12s connected to the input port Pil, those capable of performing route switching on a wavelength band in the optical signal input from the input port Pil are provided. Note that in the example illustrated in FIG. 1, as one demultiplexer 11s and three input-side WSSes 12s are connected, the total number of the input-side WSSes 12s is 3×M.

The output-side WSSes 13s are also configured on a per-wavelength-band basis, like as an S-band WSS, a C-band WSS, and an L-band WSS, and each receive an optical signal of a respective wavelength band from a demultiplexer 11s. That is, as one input-side WSS 12s and one output-side WSS 13s are connected, the total number of the output-side WSSes 13s is also 3×M.

Regarding the input-side WSSes 12s and the output-side WSSes 13s, WSSes that handle the same wavelength band are directly connected to each other in order to transmit an optical signal for which wavelength conversion is not necessary. For example, an S-band WSS of the input-side WSSes 12s is connected to, of the output-side WSSes 13s, S-band WSSes which process the same S band for which wavelength conversion is not necessary.

The input-side WSSes 12s each perform, by input-side WSSes 12s provided in the WXC unit 10s, route switching on, of the optical signals received from the input ports of the WXC device 100s, optical signals for which wavelength band conversion is not necessary, instead of inputting them to the wavelength conversion unit 20s. The input-side WSSes 12s then output the optical signals from the output ports of the WXC device 100s via the output-side WSSes 13s.

With this, an optical signal for which wavelength conversion is not necessary is transmitted without passing through the wavelength conversion unit 20s and without deterioration in the transmission quality, and is avoided from being subjected to a wavelength collision.

The input-side WSSes 12s are also connected to the wavelength conversion unit 20s. With this, an optical signal for which wavelength conversion is necessary is subjected to wavelength conversion by passing from the input-side WSS 12s through the wavelength conversion unit 20s, avoiding an wavelength collision. Further, the output-side WSSes 13s are also connected to the wavelength conversion unit 20s. With this, an optical signal on which wavelength conversion has been performed by the wavelength conversion unit 20s is subjected to route switching via an output-side WSS 13s together with an optical signal(s) for which wavelength conversion is not necessary.

The M multiplexers 14s are connected one-to-one to the M output ports, respectively. Each multiplexer 14s multiplexes single-band optical signals (an S-band optical signal, a C-band optical signal, and an L-band optical signal) input from the respective output-side WSSes 13s into a multi-band optical signal (an optical signal in which the S-band optical signal, the C-band optical signal, and the L-band optical signal have been multiplexed). Each multiplexer 14s then outputs the multiplexed optical signal to an external device from the connected output port.

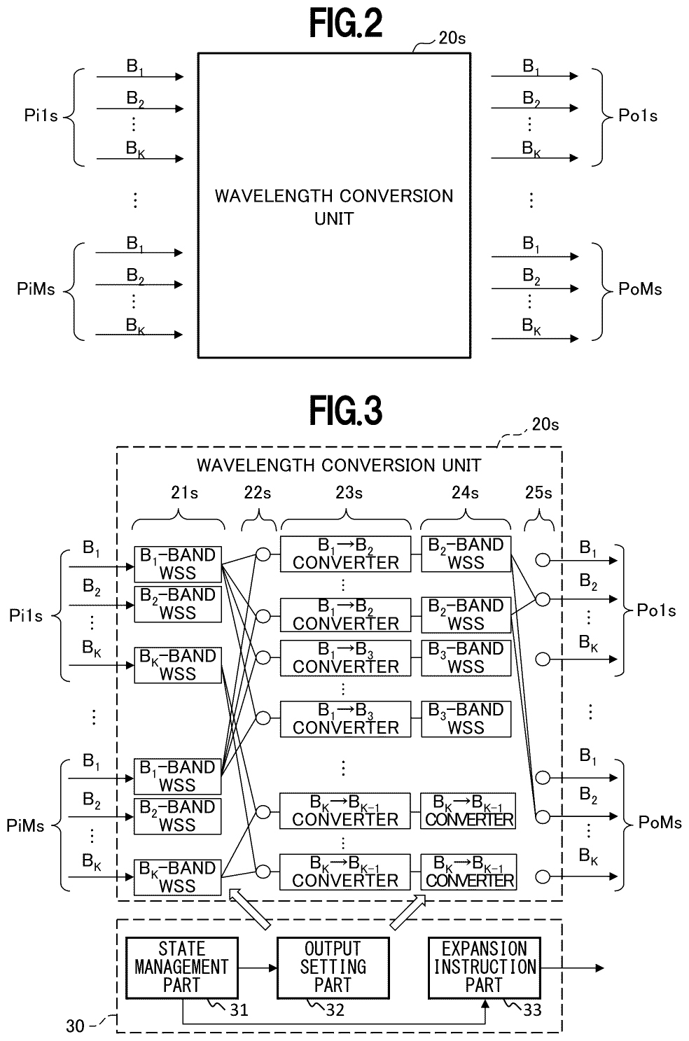

FIG. 2 is an explanatory diagram illustrating input/output lines of the wavelength conversion unit 20s with the single-band configuration. In the description of FIG. 1, the number of wavelength bands is three (S band, C band, and L band) for ease of understanding the description. On the other hand, in the description of FIGS. 2 and 3, the number of wavelength bands is generalized to K (B₁ band, B₂ band, . . . , B_{K} band).

The wavelength conversion unit 20s converts the wavelength of each optical signal input from the WXC unit 10s into a desired wavelength and performs route switching towards an output port according to a setting of optical paths. The wavelength conversion of the wavelength conversion unit 20s also includes wavelength band conversion (conversion into a wavelength of another wavelength band). For example, the wavelength conversion unit 20s receives wavelength-band-based optical signals (B₁, B₂, . . . , and B_{K}) input from the input port Pil illustrated in FIG. 1, from the input-side WSSes 12s each configured for a specific wavelength band and connected to the input port Pil of the WXC unit 10s. Similarly, the wavelength conversion unit 20s receives input of wavelength-band-based optical signals input from the input port PiM illustrated in FIG. 1.

In addition, the wavelength conversion unit 20s outputs wavelength-band-based optical signals which are to be output from the output port Pol illustrated in FIG. 1, toward the output-side WSSes 13s each configured for a specific wavelength band and connected to the output port Pol of the WXC unit 10s. Similarly, the wavelength conversion unit 20s outputs wavelength-band-based optical signals which are to be output from the output port POM illustrated in FIG. 1, toward the output-side WSSes 13s each configured for a specific wavelength band and connected to the output port POM of the WXC unit 10s.

FIG. 3 is a configuration diagram illustrating details of the wavelength conversion unit 20s and the controller 30 in the single-band configuration.

The wavelength conversion unit 20s is configured such that input-side WSSes 21s, input-side multiplexers 22s, converters 23s, output-side WSSes 24s, and output-side multiplexers 25s are connected in order of input of optical signals.

The wavelength conversion unit 20s includes, for each wavelength band and for each input port, an input-side WSS 21s capable of receiving an optical signal of a distinct wavelength band input from the WXC unit 10s.

An input-side WSS (input-side wavelength switch) 21s outputs an optical signal input from an input port of the WXC device 100s to any one of the plurality of converters 23s. For this, the input-side WSS 21s has one input terminal for receiving a wavelength-band-based optical signal input from the WXC unit 10s and one or more output terminals for outputting the optical signal to input-side multiplexers 22s each directed to a converter 23s in an unused state. Note that in FIG. 3, as the drawing becomes complicated when all the connection lines are illustrated, illustration of the connection lines between the constituent components are partially omitted.

An input-side multiplexers 22s has one or more input terminals for receiving wavelength-band-based optical signals input from the input-side WSSes 21s and one output terminal for outputting a result of multiplexing the received one or more optical signals to a converter 23s. Note that, the connection is made so that the wavelength band (e.g., B₁) of the optical signals received by the input-side multiplexer 22s from the input terminals thereof and the wavelength band (e.g., B₁ in the case of a “B₁→B₂ converter”) before conversion performed by the converter 23s that receives the optical signal output by the input-side multiplexer 22s from the output terminal thereof are consistent with each other.

A converter 23s converts the wavelength band of an optical signal input from input-side WSSes 21s, which handle the optical signals input from the input ports, into another wavelength band and outputs the converted optical signal to an output-side WSS 24s. For this, the converter 23s has one input terminal for receiving the optical signal input from the input-side multiplexer 22s and one output terminal for outputting a result of converting the wavelength band of the received optical signal into another wavelength band to the output-side WSS 24s. That is, the converter 23s is connected to the output-side WSS 24s, capable of performing route switching on the optical signal of the wavelength band after conversion. Note that, in FIG. 3, like the notation “B₁→B₂ converter”, a combination of the pre-conversion wavelength band (B₁ in this case) and the post-conversion wavelength band (B₂ in this case) of each converter 23s performing wavelength conversion is recited in the component.

In addition, both the optical signal from the input-side WSS 21s connected to the input port Pil and the optical signal from the input-side WSS 21s connected to the input port PiM are each received by the converter 23s from the input-side multiplexer 22s, to be subjected to wavelength conversion. That is, one converter 23s is shared by the input ports Pil to PiM (by the M input ports).

An output-side WSS (output-side wavelength switch) 24s performs route switching on the optical signal input from a converter 23s toward an output port of the WXC device 100s. For this, the output-side WSS 24s has one input terminal for receiving the optical signal input from the converter 23s and one or more output terminals for outputting the received optical signal to a route switching destination according to the setting of the optical path.

An output-side multiplexer 25s has one or more input terminals for receiving wavelength-band-based optical signals input from the output-side WSSes 24s and one output terminal for outputting a result of multiplexing the received one or more optical signals to an output-side WSS 13s for a specific wavelength band.

Note that the number of the converters 23s is freely selected, and it is possible to add or reduce some converters 23s as appropriate according to the usage situation of the converters 23s. Note that the input-side multiplexers 22s, the converters 23s, and the output-side WSSes 24s are each provided for the same number as they are connected one-to-one with each other.

In addition, regarding the combination of “input wavelength band→output wavelength band” to be handled by a converter 23s, any number of converters 23s can be provided for each combination of the wavelength bands, for example, three “B₁→B₂ converters” and four “B₁→B₃ converters” may be provided. In addition, in the single-band configuration, the number of input-side WSSes 21s is the product of the number of input ports (M in the case of FIG. 1) of the WXC device 100s×the number of wavelength bands (K in the case of FIG. 1) input from the input ports of the WXC device 100s.

The controller 30 manages, for each of the converters 23s, whether the converter 23s is in an in-use state or an unused state and controls the input-side WSSes 21s to output optical signals to the converters 23s in an unused state. For this purpose, the controller 30 includes a state management part 31, an output setting part 32, and an expansion instruction part 33 to manage the WXC unit 10s and the wavelength conversion unit 20s in the WXC device 100s. The controller 30 is connected to each converter 23s of the wavelength conversion unit 20s, and the state management part 31 monitors a usage situation (in-use state or unused state) of each converter 23s.

The controller 30 is connected to each WSS in the WXC device 100s. Each WSS means the input-side WSSes (second input-side wavelength switches) 12s and the output-side WSSes 13s of the WXC unit 10s and the input-side WSSes 21s and the output-side WSSes 24s of the wavelength conversion unit 20s.

The output setting part 32 sets, for the optical signal input to each WSS, which optical signal of which wavelength band is to be delivered (route-switched) to which output terminal and sets which wavelength band is to be allocated to an output terminal.

Here, the output setting part 32 references the usage situation of each converter 23s, acquired by the state management part 31, and when delivering an optical signal through an input-side WSS 21s to an input-side multiplexer 22s→a converter 23s in the subsequent stages thereof, selects the input-side multiplexer 22s directed toward a converter 23s in an unused state as the output destination. This makes it possible to avoid collision of optical signals in the converter 23s.

On the other hand, in a time period in which every converter 23s is in an in-use state, the output setting part 32 configures an input-side WSS(es) 12s of the WXC unit 10s to output an optical signal(s) to an output-side WSS(es) 13s, so that the optical signal(s) are not transmitted from the WXC unit 10s to the wavelength conversion unit 20s.

That is, when a converter 23s in an unused state is not present, the output setting part 32 does not input the optical signal(s) received from an input port(s) of the WXC device 100s to the wavelength conversion unit 20s. Instead, the output setting part 32, by performing route switching by an input-side WSS(es) 12s provided in the WXC unit 10s, performs control to output from an output port(s) of the WXC device 100s.

In addition, the expansion instruction part 33 acquires the usage situation of each converter 23s from the state management part 31, makes a future plan of expansion or reduction of the converters 23s based on an operating rate of each converter 23s, calculated from the usage situation of each converter 23s, and instructs an operator of the plan.

For example, assume that the transmission service of the optical signals has been started in a state where 100 converters 23s, 100 input-side multiplexers 22s, and 100 output-side WSSes 24s are provided. Thereafter, assume that a situation in which the operating rate of the 100 converters 23s reaches a predetermined threshold or higher, such as 95% (95 converters are always used on average) has occurred.

In this case, the expansion instruction part 33 makes a plan to add 50 converters 23s so that the total number of converters becomes 150 and makes an instruction to an operator to perform the plan. This instruction may requests the expansion be implemented such that in implementing the expansion of the converters 23s, the number of input-side multiplexers 22s be also increased to 150 in total and the number of output-side WSSes 24s be also increased to 150 in total.

With this, the operator is instructed to provide an appropriate number of converters 23s according to the usage situation of the converters 23s. Accordingly, it is possible not to redundantly increase the size of the WXC device 100s by providing a redundant number of converters 23s, and it is also possible to prevent performance insufficiency of the WXC device 100s due to an insufficient number of converters 23s.

In addition, in the WXC device 100s, the installed converters 23s are shared by all the input ports. Therefore, in comparison with a configuration in which a dedicated converter 23s is provided exclusively for one input port, expansion or reduction of the converters 23s is implemented with high flexibility, and it is possible to proactively implement expansion or reduction of the converters according to a communication load.

Moreover, in the WXC device 100s with the single-band configuration, WSSes supporting single wavelength band are used as the WSSes in the device. Consequently, it is possible to construct the WXC device 100s that includes WSSes whose mechanism is simple and thus which are inexpensive at low cost.

### Example 2

FIG. 4 is a configuration diagram illustrating a WXC device 100m with the multi-band configuration.

The WXC device 100m has a WXC unit 10m, a wavelength conversion unit 20m, and a controller 30. Similarly to Example 1, the controller 30 controls the WXC unit 10m and the wavelength conversion unit 20m.

Similarly to the WXC device 100s with the single-band configuration, the WXC device 100m is connected to external devices by optical fibers via M input ports (port Pil, . . . , port PiM) and M output ports (port Pol, . . . , port PoM). An optical signal of a plurality of wavelength bands is transmitted/received to/from the optical fiber connected to each input/output port of the WXC device 100m.

The WXC unit 10m receives an optical signal in which optical signals of a plurality of wavelength bands have been multiplexed from each input port of the WXC device 100m, inputs the received optical signal to the wavelength conversion unit 20m, and outputs an optical signal output from the wavelength conversion unit 20m from an output port of the WXC device 100m.

In the WXC unit 10m, input-side WSSes 12m and output-side WSSes 13m are connected in this order from the input port side (left side in FIG. 4). In the multi-band configuration, as there is no need to provide the demultiplexers 11s and the multiplexers 14s used in the single-band configuration, the WXC unit 10m can have a slim configuration.

The input-side WSSes 12m are each capable of receiving optical signals of wavelength bands (S band, C band, and L band) from the same input port (e.g., port Pil). As the input-side WSSes 12m and the input ports are in a one-to-one correspondence, the total number of the input-side WSSes 12m is M.

Similarly to the input-side WSSes 12s with the single-band configuration, the input-side WSSes 12m with the multi-band configuration each include an output terminal for transmitting an optical signal for which wavelength conversion is not necessary to the output-side WSSes 13m at the subsequent stage thereof and an output terminal for transmitting an optical signal for which wavelength conversion is necessary to the wavelength conversion unit 20m.

FIG. 5 is an explanatory diagram illustrating input/output lines of the wavelength conversion unit 20m with the multi-band configuration. Description will be given assuming that the number of wavelength bands is K (B₁ band, B₂ band, . . . . B_{K} band).

Similarly to the wavelength conversion unit 20s with the single-band configuration, the wavelength conversion unit 20m with the multi-band configuration converts the wavelengths of an optical signal input from the WXC unit 10m into desired wavelengths and performs route switching on the optical signal to a desired output port according to the setting of the optical path. On the other hand, in the case of the single-band configuration illustrated in FIG. 2, input/output terminals of the wavelength conversion unit 20s are provided on a per wavelength band basis, whereas in the case of the multi-band configuration illustrated in FIG. 5, input/output terminals of the wavelength conversion unit 20m are provided per port of the WXC device 100m, and a signal of a plurality of wavelength bands can be transmitted via one port.

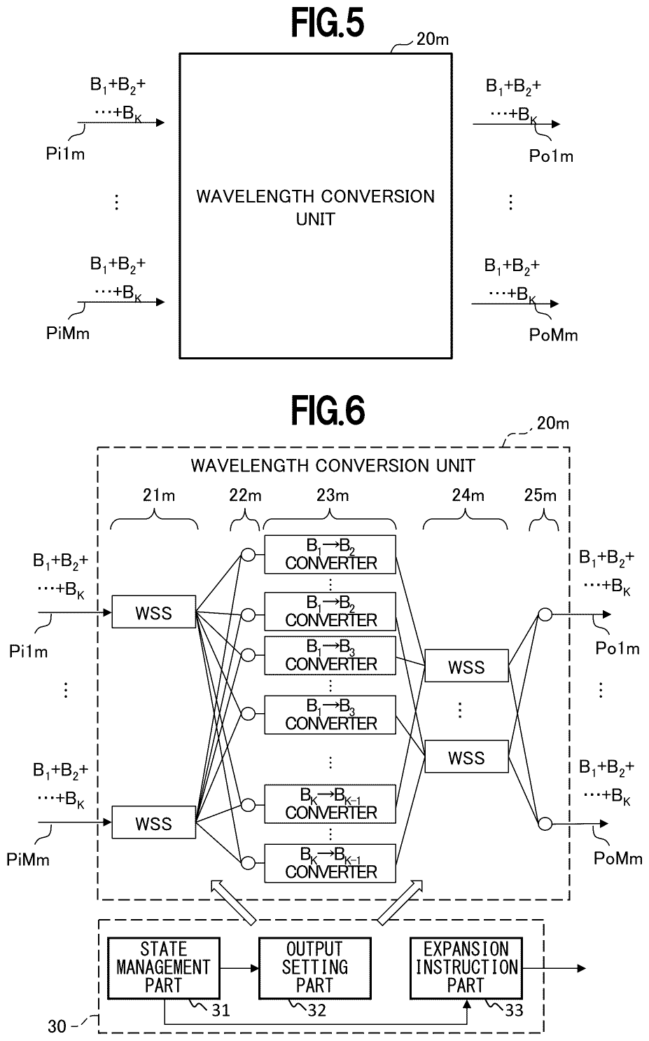

FIG. 6 is a configuration diagram illustrating details of the wavelength conversion unit 20m and the controller 30 in the multi-band configuration.

Similarly to the single-band configuration, the controller 30 with the multi-band configuration includes a state management part 31, an output setting part 32, and an expansion instruction part 33.

The state management part 31 monitors a usage situation (in-use state or unused state) of each converter 23m.

The output setting part 32 references the usage situation of each converter 23m, acquired by the state management part 31, and when delivering an optical signal through an input-side WSS 21m to an input-side multiplexer 22m→a converter 23m in the subsequent stages thereof, selects the input-side multiplexer 22m directed toward a converter 23m in an unused state as the output destination.

The expansion instruction part 33 acquires the usage situation of each converter 23m from the state management part 31, makes a future plan of expansion or reduction of the converters 23m based on an operating rate of each converter 23m, calculated from the usage situation of each converter 23m, and instructs an operator of the plan.

Hereinbelow; a list of differences (1) to (5) between the single-band configuration in FIG. 3 and the multi-band configuration in FIG. 6 will be given.

(1) Difference of Input-side WSS 21m: As the number of input terminals of the wavelength conversion unit 20m decreases from (the number of input ports)×(the number of wavelength bands) in FIG. 2 to (the number of input ports) in FIG. 5, the number of input-side WSSes 21m also decreases to the same number as the number of input ports (M). That is, the wavelength conversion unit 20m includes, for each input port, an input-side WSS 21m capable of receiving an optical signal of a plurality of wavelength bands input from the WXC unit 10m. Note that, the input-side WSSes 21s in FIG. 3 are low-functional WSSes each supporting a single band, whereas the input-side WSSes 21m in FIG. 6 each have to be a high-functional WSS supporting multi-bands.

(2) Difference of Input-side Multiplexer 22m: The number of input-side multiplexers 22m is the same as the number of converters 23m connected one-to-one thereto in both the single-band configuration illustrated in FIG. 3 and the multi-band configuration illustrated in FIG. 6. Note that, as the number of input-side WSSes 21m illustrated in FIG. 6 has been decreased, the wiring between the input-side WSSes 21m and the input-side multiplexers 22m is simplified.

(3) Difference of Converter 23m: There is no difference. In both the single-band configuration illustrated in FIG. 3 and the multi-band configuration illustrated in FIG. 6, the number of converters can be flexibly changed according to the usage situations of the converters 23m.

(4) Difference of Output-side WSS 24m: The output-side WSSes 24s illustrated in FIG. 3 are each a low-functional WSS supporting a single band, whereas the output-side WSSes 24m illustrated in FIG. 6 each have to be a high-functional WSS supporting multi-bands. However, as the output-side WSSes 24m each support multi-bands and by connecting a plurality of converters 23m and one output-side WSS 24m (n-to-one) such that the converted wavelength bands do not overlap, the number of output-side WSSes 24m can be decreased.

(5) Difference of Output-side Multiplexer 25m: As the number of output terminals of the wavelength conversion unit 20m has decreased from (the number of output ports)×(the number of wavelength bands) illustrated in FIG. 2 to (the number of output ports) illustrated in FIG. 5, the number of output-side multiplexers 25m also has decreased to the same number as the number of output ports (M). The single-band configuration in FIG. 3 and the multi-band configuration in FIG. 6 are the same in that the output-side WSSes 24m and the output-side multiplexers 25m are connected per output port.

As described above, the WXC unit 10m and the wavelength conversion unit 20m can, by using the high-functional WSSes supporting multi-bands, reduce the number of WSSes, construct the WXC device 100m in a space-saving manner and operate it in a power-saving manner.

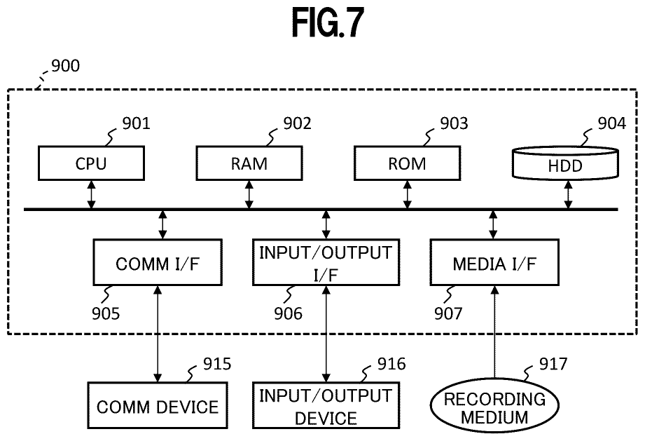

FIG. 7 is a hardware configuration diagram of the controller 30.

The controller 30 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads/writes data from/to a recording medium 917. Further, the CPU 901 controls each component by executing a program (also referred to as an application or an app for abbreviation thereof) read into the RAM 902. The program can be delivered via a communication line or delivered by being recorded in the recording medium 917 such as a CD-ROM.

Alternatively, the controller 30 may be implemented with a field programmable gate array (FPGA) or an application specific integrated circuit (ASIC) in which logic of the program is implemented, instead of the CPU 901 of the computer 900 executing the program. Further, the controller 30 may be configured in a housing separate from the WXC device 100s or 100m, and one controller 30 may manage a plurality of WXC devices 100s and 100m.

### Effects

In the present invention, the WXC device 100s includes the wavelength conversion unit 20s; and the controller 30. The wavelength conversion unit 20s includes:
the input-side WSSes 21s each configured to output an optical signal input from an input port of the WXC device 100s to any one of the plurality of converters 23s;
the converters 23s, each configured to convert the wavelength band of the optical signal input from each input-side WSS 21s, which handles the optical signal input from an input port, into another wavelength band and output the converted optical signal to an output-side WSS 24s; and
the output-side WSS 24s, configured to perform route switching on the optical signal input from the converter 23s toward an output port of the WXC device 100s.

The controller 30 is configured to manage whether each converter 23s is in an in-use state or an unused state and control the input-side WSSes 21s to output optical signals to the converters 23s in an unused state.

With this, by employing the trunk-type configuration, in which processing components that perform wavelength conversion on the optical signal input from each input port are aggregated into the wavelength conversion unit 20s, it is possible to flexibly implement expansion or reduction of the converters 23s according to the demand. In addition, the converters 23s are not provided per input port but are shared by a plurality of input ports.

Further, by controlling the input-side WSSes 21s each to output the optical signal to a converter 23s in an unused state, the operating rate of the converters 23s can be improved, and the number of converters 23s can be reduced. As described above, by reducing the number of converters 23s to a necessary number, the cost of the WXC device 100s can be reduced.

As described above, the present invention proposes the configuration of a WXC device for which an appropriate number of converters to be included in the WXC device can be set.

In the present invention, the WXC device 100s further includes the WXC unit 10s.

The WXC unit 10s is configured to:
receive, from each input port of the WXC device 100s, an optical signal in which optical signals of a plurality of wavelength bands have been multiplexed;
input optical signals resulted in demultiplexing the received optical signal into distinct wavelength bands to the wavelength conversion unit 20s;
multiplex optical signals of the distinct wavelength bands output from the wavelength conversion unit 20s; and
output the multiplexed optical signals from output ports of the WXC device 100s.

The wavelength conversion unit 20s includes the input-side WSSes 21s, each capable of receiving an optical signal of an distinct wavelength band input from the WXC unit 10s and each provided per a wavelength band and an input port.

With this, the cost of the WXC device 100s can be reduced by using the low-cost input-side WSSes 21s each supporting a single band in the wavelength conversion unit 20s.

In the present invention, the WXC device 100m further includes the WXC unit 10m.

The WXC unit 10m is configured to:
receive, from each input port of the WXC device 100m, an optical signal in which optical signals of a plurality of wavelength bands have been multiplexed;
input the received optical signal to the wavelength conversion unit 20m; and
output optical signals output from the wavelength conversion unit 20m from output ports of the WXC device 100m.

The wavelength conversion unit 20m includes the input-side WSSes 21m, each capable of receiving an optical signal of a plurality of wavelength bands input from the WXC unit 10m and each provided per an input port.

With this, by using the high-functional input-side WSSes 21m each supporting multi-bands in the wavelength conversion unit 20m, it is possible to reduce the number of input-side WSSes 21m and simplify the wiring layout and thus reduce the size of the WXC device 100m.

In the present invention, the WXC unit 10s is configured to output, of optical signals received from the input ports of the WXC device 100s, an optical signal for which wavelength band conversion is not necessary from an output port of the WXC device 100s by performing route switching on the optical signal by an input-side WSS 12s provided in the WXC unit 10s, instead of inputting the optical signal to the wavelength conversion unit 20s.

With this, the optical signals for which wavelength band conversion is not necessary can be transmitted at high speed by bypassing the wavelength conversion unit 20s.

In the present invention, the controller 30 is configured to perform control to, when there is no converter 23s in an unused state, instead of inputting an optical signal received from an input port of the WXC device 100s to the wavelength conversion unit 20s, perform route switching on the optical signal by an input-side WSS 12s provided in the WXC unit 10s to output the optical signal from an output port of the WXC device 100s.

With this, in a state where there is no available converter 23s, the optical signal can be processed without a loss by bypassing the wavelength conversion unit 20s.

### REFERENCE SIGNS LIST

100s, 100m WXC device (wavelength cross connect device)
10s, 10m WXC unit (wavelength cross connect unit)
11s Demultiplexer
12s, 12m Input-side WSS (second input-side wavelength switch)
13s, 13m Output-side WSS
14s Multiplexer
20s, 20m Wavelength conversion unit
21s, 21m Input-side WSS (input-side wavelength switch)
22s, 22m Input-side multiplexer
23s. 23m Converter
24s. 24m Output-side WSS (output-side wavelength switch)
25s. 25m Output-side multiplexer
30 Controller
31 State management part
32 Output setting part
33 Expansion instruction part

1-6. (canceled)

7. A wavelength cross connect device comprising:
one or more input ports;
one or more output ports;
a wavelength conversion unit comprising one or more input-side wavelength switches, a plurality of wavelength converters, and a plurality of output-side wavelength switches; and
a controller,
wherein each of the one or more input-side wavelength switches is configured to output an optical signal input from a corresponding one of the one or more input ports to a selected one of the plurality of wavelength converters,
wherein each of the plurality of wavelength converters is configured to convert a wavelength band of the optical signal input from each of the one or more input-side wavelength switches into another wavelength band and output the converted optical signal to a respective one of the plurality of output-side wavelength switches,
wherein each of the plurality of output-side wavelength switches is configured to perform route switching on the optical signal input from a respective one of the plurality of wavelength converters toward a selected one of the one or more output ports of the wavelength cross connect device, and
wherein the controller is configured to:
manage, for each of the plurality of wavelength converters, whether the wavelength converter is in an in-use state or an unused state to identify zero or more unused wavelength converters among the plurality of wavelength converters; and
control each of the one or more input-side wavelength switches to output the optical signal input to the input-side wavelength switch to one of the zero or more unused wavelength converter.

8. The wavelength cross connect device according to claim 7, further comprising a wavelength cross connect unit,
wherein the wavelength cross connect unit is configured to:
receive, from each of the one or more input ports, a first multi-band optical signal in which optical signals of a plurality of distinct wavelength bands have been multiplexed;
demultiplex the first multi-band optical signal into first single-band optical signals each having respective one of the plurality of distinct wavelength bands;
input the first single-band optical signals to the wavelength conversion unit;
multiplex second single-band optical signals of the plurality of distinct wavelength bands output from the wavelength conversion unit into a second multi-band optical signal; and
output the second multi-band optical signal from one of the one or more output ports,
wherein the one or more input-side wavelength switches are each provided per a combination of one of the distinct wavelength bands and one of the one or more input ports, and
wherein the one or more input-side wavelength switches are each configured to receive, as the optical signal input from the corresponding one of the one or more input ports, one of the single-band optical signals demultiplexed from the first multi-band optical signal received from the corresponding one of the one or more input ports and input to the wavelength conversion unit by the wavelength cross connect unit.

9. The wavelength cross connect device according to claim 7, further comprising a wavelength cross connect unit,
wherein the wavelength cross connect unit is configured to:
receive, from each of the one or more input ports, a multi-band optical signal in which optical signals of a plurality of distinct wavelength bands have been multiplexed;
input the multi-band optical signal to the wavelength conversion unit; and
output optical signals output from the wavelength conversion unit each from one of the one or more output ports, and
wherein the one or more input-side wavelength switches are each provided per one of the one or more input ports, and
wherein the one or more input-side wavelength switches are each configured to receive, as the optical signal input from the corresponding one of the one or more input ports, the multi-band optical signal received from the corresponding one of the one or more input ports and input to the wavelength conversion unit by the wavelength cross connect unit.

10. The wavelength cross connect device according to claim 8,
wherein the wavelength cross connect unit further comprises one or more second input-side wavelength switches, and
wherein the wavelength cross connect unit is further configured to output, of multi-band optical signals received from the one or more input ports, a third multi-band optical signal for which wavelength band conversion is not necessary from a selected one of the one or more output ports by demultiplexing the third multi-band optical signal into third single-band optical signals each having respective one of the plurality of distinct wavelength bands and by performing route switching on the third single-band optical signals by corresponding ones of the one or more second input-side wavelength switches, instead of inputting the third single-band optical signals to the wavelength conversion unit.

11. The wavelength cross connect device according to claim 9,
wherein the wavelength cross connect unit further comprises one or more second input-side wavelength switches, and
wherein the wavelength cross connect unit is further configured to output, of multi-band optical signals received from the one or more input ports, a first multi-band optical signal for which wavelength band conversion is not necessary from a selected one of the one or more output ports by performing route switching on the first multi-band optical signal by a corresponding one of the one or more second input-side wavelength switches, instead of inputting the first multi-band optical signal to the wavelength conversion unit.

12. The wavelength cross connect device according to claim 10,
wherein the controller is further configured to, when none of the plurality of wavelength converters is in an unused state:
demultiplex a multi-band optical signal in which optical signals of the plurality of distinct wavelength bands have been multiplexed and which has been received from one of the one or more input ports into fourth single-band optical signals each having respective one of the plurality of distinct wavelength bands; and
perform route switching on the fourth single-band optical signals by corresponding ones of the one or more second input-side wavelength switches to be directed towards a selected one of the one or more output ports, instead of inputting the fourth single-band optical signals to the wavelength conversion unit.

13. The wavelength cross connect device according to claim 11,
wherein the controller is further configured to, when none of the plurality of wavelength converters is in an unused state,
on a second multi-band optical signal in which optical signals of the plurality of distinct wavelength bands have been multiplexed and which has been received from one of the one or more input ports, perform route switching by a corresponding one of the one or more second input-side wavelength switches to output the second multi-band optical signal from a selected one of the one or more output ports, instead of inputting the second multi-band optical signal to the wavelength conversion unit.

14. A wavelength cross connect method to be executed by a wavelength cross connect device, wherein the wavelength cross connect device comprises:
one or more input ports;
one or more output ports;
a wavelength conversion unit comprising one or more input-side wavelength switches, a plurality of wavelength converters, and a plurality of output-side wavelength switches; and
a controller,
each of the one or more input-side wavelength switches configured to output an optical signal input from a corresponding one of the one or more input ports to a selected one of the plurality of wavelength converters,
each of the plurality of wavelength converters configured to convert a wavelength band of the optical signal input from each of the one or more input-side wavelength switches into another wavelength band and output the converted optical signal to a respective one of the plurality of output-side wavelength switches,
each of the plurality of output-side wavelength switches configured to perform route switching on the optical signal input from a respective one of the plurality of wavelength converters toward a selected one of the one or more output ports of the wavelength cross connect device,
wherein the wavelength cross connect method comprises:
managing, by the controller, for each of the plurality of wavelength converters, whether the wavelength converter is in an in-use state or an unused state to identify zero or more unused wavelength converters among the plurality of wavelength converters; and
controlling, by the controller, each of the one or more input-side wavelength switches to output the optical signal input to the input-side wavelength switch to one of the zero or more unused wavelength converter.
